(19) United States
(12) Patent Application Publication
(10) Pub. No.: US 2005/0284154 A1
(43) Pub. Date: Dec. 29, 2005

(54) System and method for storing hydrogen at cryogenic temperature

(76) Inventors: Andrew Maxwell Peter, Saratoga Springs, NY (US); Sukla Chandra, Bangalore (IN)

Correspondence Address: Patrick S. Yoder;FLETCHER YODER, P.O. Box 692289, Houston, TX, 77269-2289, US

(21) Appl. No.: 10/876,927

(22) Filed: Jun. 25, 2004

(51) Int. Cl. F17C 1/00; F17C 13/08; C10G 1/06; C10G 1/08

(52) U.S. Cl. 62/45.1; 62/53.2

(57) ABSTRACT

A system and method for processing hydrogen is disclosed. The system may include at least one compressor adapted to compress hydrogen from the source to a storage pressure in the range of 2,000 pounds per square inch (PSI) to 10,000 pounds per square inch (PSI), and a cooling mechanism coupled to the compressor for cooling the hydrogen to a storage temperature of about liquid nitrogen temperature.

### BACKGROUND

The invention relates generally to the production and storage of hydrogen and, more particularly, to a system and method for storing hydrogen at reduced temperature and increased pressure to improve the available storage energy density of the hydrogen.

Hydrogen is typically produced in bulk in steam methane reforming plants. The hydrogen storage energy density is then typically improved through compression or liquefaction. In a hydrogen liquefaction plant, feed gas is cooled and liquefied using multiple heat exchangers. Liquefaction plants are typically extremely large, with a correspondingly large investment with respect to fixed cost and operating cost. An important contributor to the large cost of operating a liquefaction plant is the large amount of electricity needed to liquefy hydrogen.

As interest in hydrogen as an alternative fuel to oil and natural gas has increased in recent years, hydrogen storage has been the subject of intensive research. Hydrogen is a promising alternative fuel because it creates less pollution than fossil fuels and can readily be produced from renewable energy resources, thus eliminating the net production of greenhouse gases. Because of its relatively high availability and low cost, hydrogen is a candidate for, among other things, alternative fuel vehicles.

Hydrogen contains more chemical energy per weight than any hydrocarbon fuel, but it is also the lightest existing substance. Hydrogen is, therefore, problematic to store effectively in small containers. One approach to storing hydrogen involves the use of metals and alloys, which are reacted with hydrogen to form metal hydrides. However, these storage methods have several disadvantages. For example, the use of metal hydrides adds undesirable weight to storage tanks. Other disadvantages may include undesirably large volume or weight, boiling loss or energy loss during charging and discharging with hydrogen.

Furthermore, if hydrogen is to be used as a fuel for transport, it must be stored in a cost-effective manner. The lack of a convenient and cost-effective hydrogen storage system makes it difficult to introduce hydrogen on a large scale for use in vehicles and other applications. Storage of 5 kg of gaseous hydrogen (equivalent in terms of energy to about 16 liters or about 4.2 gallons of gasoline) may be considered a minimum practical requirement for a general-purpose vehicle because that amount of fuel could provide an approximate 448 km (about 278 miles) range at a consumption rate of 28-km/liter. The external volume for a pressure vessel storing 5 kg of hydrogen at 13.8 megapascals (Mpa) or 2,000 pounds per square inch (PSI) and room temperature (20° C. or 68° F.) is at least 500 liters. This volume is too large to be practically used in many applications, such as light duty vehicles. If hydrides are used, the weight of the overall storage container is problematic. A hydride storage system may weigh 300 kg for 5 kg of hydrogen, resulting in a substantial reduction in vehicle fuel economy and performance.

The alternative of low-pressure liquid hydrogen storage provides the advantages of reduced weight and compactness. However, liquid hydrogen typically has high boiling losses in a non-insulated vessel. It is also relatively expensive to maintain liquid hydrogen at a sufficiently low temperature. Evaporative losses that occur during periods of inactivity because of environmental heat transfer add to system inefficiency.

The aforementioned problems with uninsulated containers for low temperature storage have led to experimentation with insulated storage containers. Insulated storage containers offer improved performance relative to uninsulated storage containers, but insulated containers are still not effective enough to be practical in widespread use. Low-pressure storage vessels tend to have high evaporation losses because of evaporation and leaks. Also, losses from a hydrogen vessel in a vehicle tend to grow rapidly as the daily driving distance drops. In addition to these disadvantages, low temperature storage typically requires a high-pressure pump for effective delivery of hydrogen to an engine. The high-pressure pump adds significant cost to the fuel delivery system.

Liquefaction of hydrogen is a very energy-intensive process. Even at a very large scale (several tons per day) using state-of-the-art technology, the liquefaction process consumes at least about 30% of the energy content of the hydrogen itself, as measured by the lower heating value (LHV).

There is a need, therefore, for an improved technique for storing hydrogen in an efficient and cost-effective manner. In particular, a need exists for a technique that can be employed to facilitate the efficient and cost-effective storage of hydrogen for use as a vehicle fuel.

### BRIEF DESCRIPTION

In accordance with one aspect of the present technique, a system and method are illustrated for producing and storing hydrogen at low temperature and high pressure. Such a system may comprise at least a compressor for compressing hydrogen from an atmospheric pressure to a storage pressure, at least an intercooler coupled to the compressor for cooling the hydrogen, a cooling system for cooling the hydrogen at the storage pressure and a temperature equivalent to about liquid nitrogen temperature for storage, and a storage vessel to store the hydrogen for end application.

In accordance with another aspect of the present technique, a system for storing hydrogen in a motor vehicle at liquid nitrogen temperature is illustrated, wherein the hydrogen is utilized as a fuel for a vehicle engine.

In accordance with yet another aspect of the present technique a method is described for processing hydrogen at liquid nitrogen temperature.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram illustrating a system for producing and storing hydrogen in accordance with an exemplary embodiment of the present technique;

FIG. 2 is a schematic diagram illustrating a system for compressing a hydrogen feed to about liquid nitrogen temperature as illustrated in FIG. 1 in accordance with an exemplary embodiment of the present technique;

FIG. 3 is a diagrammatic representation illustrating a cryogenic storage pressure vessel for storing hydrogen in accordance with an exemplary embodiment of the present technique;

FIG. 4 is a schematic diagram illustrating a system for hydrogen production, storage and application in accordance with an exemplary embodiment of the present technique;

FIG. 5 is a diagrammatic representation illustrating an equilibrium ortho-para concentration of hydrogen vs. temperature in accordance with an exemplary embodiment of the present technique;

FIG. 6 is a diagrammatic representation illustrating the volumetric energy density of hydrogen vs. pressure in accordance with an exemplary embodiment of the present technique; and

FIG. 7 is a flow chart illustrating a method of processing hydrogen in accordance with an exemplary embodiment of the present technique.

### DETAILED DESCRIPTION

The present technique discloses a system and method for storing hydrogen at cryogenic temperatures.

The problems to be solved by the present technique are further explained with reference to the Figures, wherein like features are designated with like reference numerals.

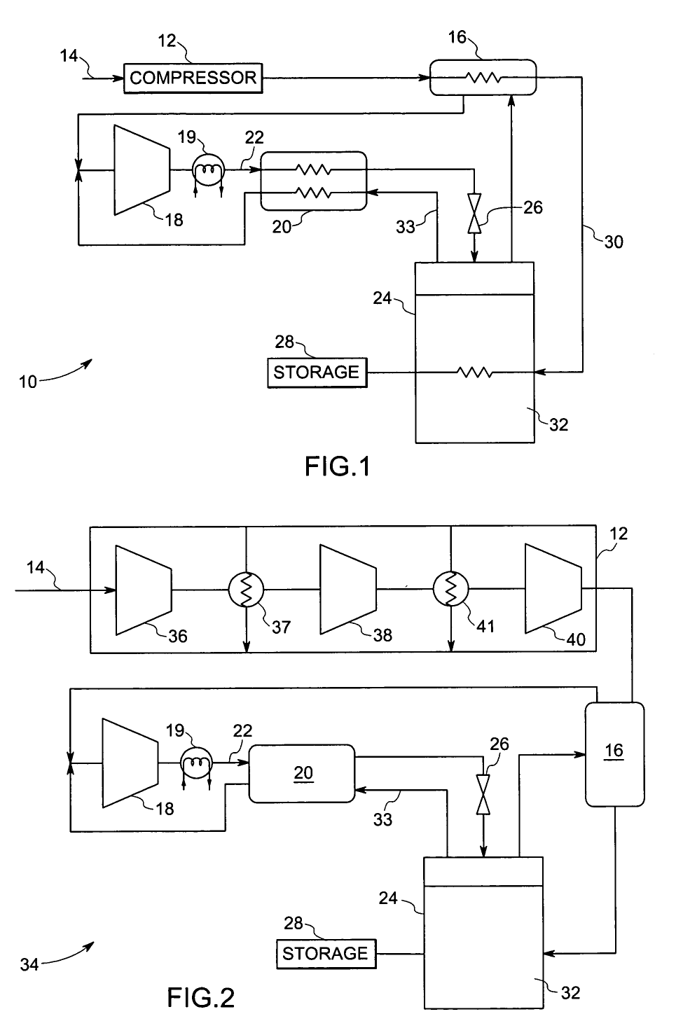

Turning now to the drawings, FIG. 1 illustrates a system 10 for producing and storing hydrogen. The system 10 comprises a compressor 12 for compressing hydrogen fed from a hydrogen source 14 to a heat exchanger 16, another compressor 18 for compressing nitrogen gas, a heat exchanger 19 for cooling the hot nitrogen gas leaving the compressor 18, a heat exchanger 20 for cooling the compressed nitrogen 22, a liquid nitrogen storage vessel 24, a valve 26, which may be a Joule Thompson valve, and a storage vessel 28. The heat exchanger 19 is adapted to cool the hot nitrogen gas to ambient conditions through heat exchange with ambient water, air, or any other refrigeration cycles known in the art.

Heat generated during the compression of hydrogen in the compressor 12 is removed in the heat exchanger 16 and the cooled hydrogen 30 flows to the liquid nitrogen vessel 24. As a fundamental feature of storing compressed hydrogen, the amount of hydrogen stored correlates directly with the storage temperature. An effective way of enhancing the storage of hydrogen is to reduce the temperature of storage. Liquid nitrogen 32 is relatively inexpensive and widely available. Therefore it is a practical cooling media for cooling hydrogen gas. However, the coolant used in both the heat exchangers 16 and 20 could be air or any other cryogenic coolant wherein temperature of the cooling media can vary from about 77 degrees Kelvin to about 4 degrees Kelvin. In one such embodiment of the present technique, liquid nitrogen 32 is used as a cooling media for the heat exchangers 16 and 20 to cool the compressed hydrogen. The temperature of liquid nitrogen is at about 77 degrees K.

In the arrangement illustrated in the FIG. 1, nitrogen gas is used as a refrigerant in a Linde cycle, as described below. However, the mechanism may also include a cascade of Linde cycles, each with a different refrigerant gas to cool the hydrogen. Those of ordinary skill in the art will appreciate, however, that other refrigeration cycles like the Claude cycles and the Brayton cycles are believed to be acceptable for the present technique. The nitrogen gas after being compressed in the compressor 18 is passed through the heat exchanger 19 for cooling to ambient temperature and is then further passed through the heat exchanger 20. The compressed nitrogen 22 is pre-cooled by the flow of evaporated nitrogen gas 32 flowing from the liquid nitrogen vessel 24. The cooled nitrogen gas after dispensing out from the heat exchanger 20 flows through the valve 26, wherein the gaseous nitrogen is cooled to liquid nitrogen 32, and is finally stored in the liquid nitrogen vessel 24. In the embodiment illustrated, the evaporated nitrogen gas 33 is used for cooling the compressed nitrogen gas prior to its passage through the valve 26. Similarly, the same liquid nitrogen 32 is utilized in the heat exchanger 16 for cooling the compressed hydrogen prior to its passage to the liquid nitrogen vessel 24. The cooled hydrogen, after passing from the heat exchanger 20, passes through the liquid nitrogen vessel 24 where the hydrogen is cooled to about liquid nitrogen temperature before it is stored in the storage vessel 28.

In one embodiment of the present technique, a Linde cycle is utilized to cool the gaseous hydrogen to liquid nitrogen temperature. In another embodiment of the present technique, the cooling can be achieved using a mixed refrigerant cycle comprising a single compressor, at least two gaseous refrigerant mixed together, at least two valves, which may comprise Joule Thompson valves, and at least two heat exchangers to cool the hydrogen. In the Brayton cycle mentioned above, the cooling mechanism cools the hydrogen directly using the hydrogen, where the hydrogen is compressed beyond the delivery pressure, cooled with air or water, and the expanded to the delivery pressure and temperature. In the Claude cycle, the hydrogen is compressed in at least a compressor with at least one stage, cooled in an evaporative cooler and then passed through at least a heat exchanger wherein the coolant is liquid nitrogen and then finally expanded through an expansion valve. Hence through this process, the hydrogen is cooled to liquid nitrogen temperature. In yet another embodiment of the present technique, the cooling mechanism is adapted to cool the hydrogen using a magnetic refrigerator comprising a magnetocaloric regenerator and a superconducting magnet. Magnetic refrigeration is based on the magnetocaloric effect (MCE), an intrinsic property of all magnetic materials that peaks in the vicinity of the magnetic ordering temperature. The magnetocaloric effect depends on the way a material's atomic spins align themselves. All materials store heat in the form of atomic vibrations. An applied magnetic field forces the atoms into alignment, reducing the system's heat capacity and causing it to expel energy, which the water or any coolant carries away. When the field is removed, the atoms randomize again and can absorb energy from their surroundings, creating a cooling effect. In the case of a ferromagnetic material, it is the warming as the magnetic moments of the atoms are aligned on the application of a magnetic field, and the cooling when the magnetic moments become randomly oriented on removing the magnetic field. The warming and the cooling of a magnetic material in response to a changing magnetic field is similar to the warming and the cooling of a gaseous medium in response to compression and expansion. Therefore, magnetic refrigeration operates by magnetizing/demagnetizing the magnetic material.

Referring to FIG. 2, a system 34 for compressing a source of hydrogen to about liquid nitrogen temperature is illustrated. In the embodiment illustrated in FIG. 2, hydrogen is compressed via a series of compressors. Those of ordinary skill in the art will appreciate that other embodiments may comprise a single hydrogen compressor 12 with one or multiple stages or a series of hydrogen compressors with one or multiple stages. Hydrogen is compressed in a first stage 36 and then cooled in the first intercooler 37. The hydrogen is then compressed further in a second stage 38 and a third stage 40. Between each stage of the compression, an intercooler 37 may be used to cool the compressed hydrogen. In FIG. 2, the intercooler 37 is located between the first stage 36 of the compressor and the second stage 38 of compressor. Likewise, another intercooler 41 is present between the second stage 38 of compressor and the third stage 40 of the compressor. The intercoolers 37 and 41 help to decrease the temperature generated during compression in the compressor stages. In the illustrated embodiment, the coolant used in the intercoolers may be water, air, evaporated nitrogen or the like.

In practice, depending on the heat generated, multiple heat exchangers could be employed to cool the compressed hydrogen. The number of heat exchangers used for cooling the compressed nitrogen 22 in the compressor 20 may also vary depending on system design requirements. In an exemplary embodiment of the present technique, diaphragm compressors are employed to compress hydrogen. The basic design of a diaphragm compressor may help to provide leak resistant and non-contaminating gas compression. However, those of ordinary skill in the art will appreciate that other types of compressors may be employed in embodiments of the present technique. Additionally, the nitrogen gas compressor 18 need not be of the same type or size as the hydrogen compressor 12.

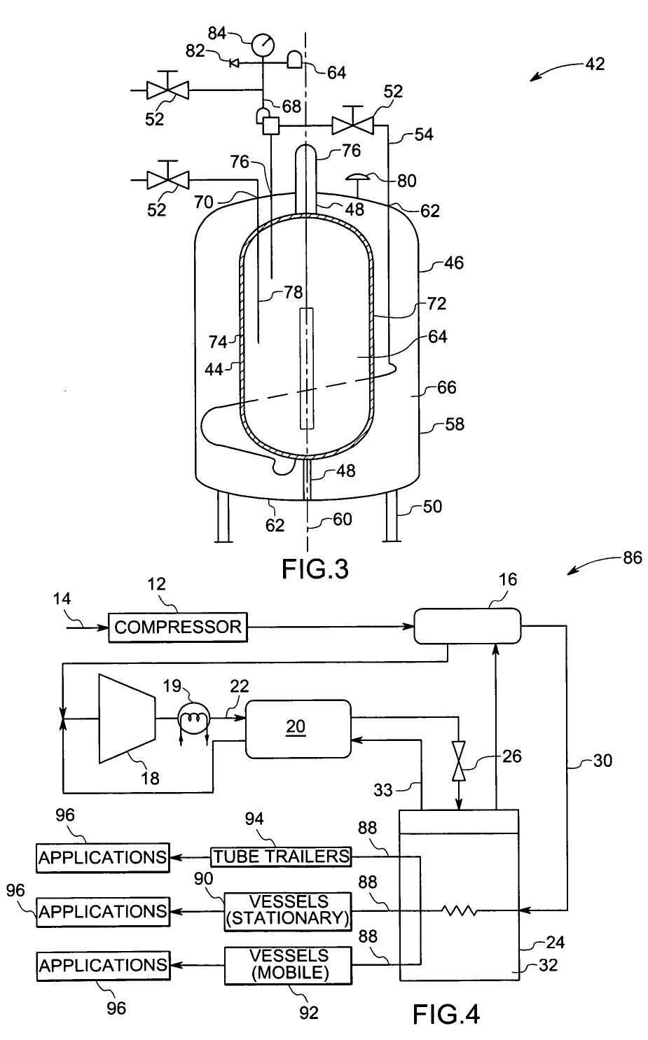

FIG. 3 discloses an exemplary embodiment of a storage vessel 42. The present technique illustrates one embodiment of the structure of the storage vessel 42 and the various component of the storage vessel 42 comprising an inner vessel 44, an outer vessel 46, an insulated support structure 48 for the inner vessel 44, a support structure 50 for the outer vessel 46, a plurality of interconnecting valves 52 and pipelines 54 for flow control of hydrogen in and out of the storage vessel 42. The storage vessel 42 described herein, generally has an elongated cylindrical configuration along a central axis 60 with rounded elliptical or torispherical or hemispherical ends 62. Furthermore, the storage vessel 42 includes an inner vessel 44 surrounding and enclosing a storage volume 64, and an outer vessel 46 surrounding the inner vessel 44 to form an evacuated space 66 there between. Insulated support structure 48 separates and suspends the inner vessel 44 from the outer vessel 46, to prevent heat conduction there between. Access into and out of the storage volume 64 is by an inlet port 68 and an outlet port 70 extending through the inner vessel 44 and the outer vessel 46. The outer vessel 46 has a lightweight rigid body construction capable of supporting the evacuated space 66 therein, with aluminum or stainless steel being exemplary material types used for its construction and also for the construction for the inner vessel 44.

As described above, weight is an important consideration in the design of hydrogen storage containers, especially for vehicular applications. In the embodiment illustrated in FIG. 3, the inner vessel 44 may comprise a lightweight rigid structure having a high strength to weight ratio. Moreover, the construction of the inner vessel 44 may be designed to withstand high pressures (due to compressed gas storage) from within the storage volume 64. For example, it may be desirable to store hydrogen compressed to a range of between about 2,000 pounds per square inch to about 10,000 pounds per square inch.

The storage vessel 42 may also include a thermal insulator 72 surrounding the inner vessel 44 in the evacuated space 66. The thermal insulator 72 serves to inhibit radiative heat transfer to the storage volume 64. One exemplary embodiment of the thermal insulator 72 comprises an external multilayer super insulation (MLSI) 74. The MLSI 74 reduces the heat radiation thereby reducing vapor losses, especially during cryogenic operation. The outer vessel 46 operates to keep a vacuum around the inner vessel 44, which is helpful for effective operation of the MLSI 74. The MLSI 74 exhibits good thermal performance when under a relatively high vacuum, for example, at a pressure lower than about 10⁻⁵ millibar (Mbar).

The hydrogen, which is cooled by the nitrogen storage vessel 24 (FIG. 1) is delivered to the storage vessel 42 by an inlet pipeline 76 and is dispensed out of the storage vessel 42 through an outlet pipeline 78. The storage vessel 42 also contains a bursting disc 80 and a safety valve 82 for safe operation of the storage vessel 42. The quantity of hydrogen present in the storage vessel 42 is measured using a level indicator 84.

FIG. 4 describes an exemplary system 86 for hydrogen production, storage and application. The system comprises a compressor 12 for compressing a source of hydrogen 14 delivered to the heat exchanger 16 for cooling the compressed hydrogen and is then passed through the liquid nitrogen vessel 24 wherein the hydrogen is cooled to about liquid nitrogen temperature. Similarly, the nitrogen refrigerant is compressed in the compressor 18 and is passed through the heat exchanger 20 wherein the compressed nitrogen 22 is initially cooled. The nitrogen is then isenthalpically expanded in the valve 26, which may convert the cooled compressed nitrogen to liquid nitrogen 32 used for cooling the hydrogen. The hydrogen cooled to about liquid nitrogen temperature is stored in the storage vessel 28, which may then be used for various applications. In one embodiment of the present technique, the compressed, cooled hydrogen 88 at about liquid nitrogen temperature is stored in either a stationary storage vessel 90, or in a mobile storage vessel 92 for automobiles. In another embodiment, hydrogen is stored as tube trailers 94 for a merchant market where the hydrogen at low temperature is transported from the point of production to the point of use. In yet another embodiment the hydrogen is used for any stationary application as well as mobile applications. As indicated in the FIG. 4, the storage vessels may be used in any of a plurality of applications 96.

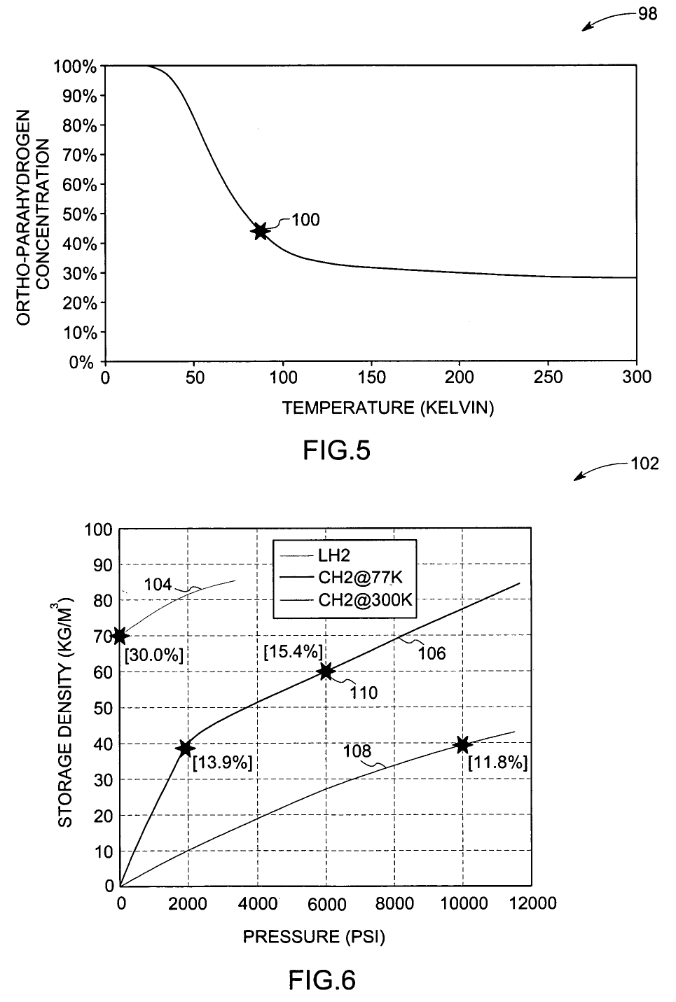

FIG. 5 is an exemplary diagrammatic representation illustrating an equilibrium ortho-para concentration of hydrogen versus temperature (measured in degrees Kelvin). The diagram shown in FIG. 5 is generally referred to by the reference numeral 98. Ortho and para are the isomers of hydrogen. At about 300 degrees Kelvin, hydrogen may comprise about 25% para isomers and about 75% ortho isomers. In the liquid hydrogen state at roughly 20 degrees Kelvin, the equilibrium concentration may be about 99.8% para hydrogen. In the liquid state, ortho hydrogen may spontaneously convert to para hydrogen, producing heat as the result of an exothermic reaction. The heat released by the exothermic reaction may be greater than the heat of vaporization, undesirably increasing the boil off of hydrogen. It is generally observed that the boil off is about 12% per day if the ortho hydrogen is not previously converted during the liquefaction process.

In embodiments of the present technique, it has been observed that, at a storage temperature of about 77 degrees Kelvin, the equilibrium of hydrogen is about 60% ortho hydrogen, indicating that only a small amount of ortho hydrogen is converted to para hydrogen. Accordingly, less heat is released. Thus, storing hydrogen at about liquid nitrogen temperature removes or reduces the desirability of expending additional energy to facilitate the ortho-para conversion that is otherwise needed if a lower storage temperature is desired. Based on the energy density data illustrated in FIG. 6 below, this means that there is a relative improvement in the energy density of storing hydrogen at about liquid nitrogen temperature with respect to the energy expenditure required to cool hydrogen to about liquid nitrogen temperature. In other words, storing hydrogen at about liquid nitrogen temperature may provide improved energy conversion efficiency compared to storing hydrogen in liquid form.

FIG. 6 is an exemplary diagrammatic representation illustrating the volumetric energy density of hydrogen indicated in kilograms per cubic meter (Kg/M³) versus pressure indicated by pounds per square inch absolute (PSI). The diagram shown in FIG. 6 is generally referred to by the reference numeral 102. In the present embodiment, the line 104 indicates the properties of liquid hydrogen. The line 104 indicates that, at atmospheric pressure, the storage density is around 70 Kg/M³. In the case of compressed hydrogen at about liquid nitrogen temperature (shown by a line 106), the storage density is around 40 Kg/M³ at about 2,000 PSI. At about 6,000 PSI, the storage density is about 60 Kg/M³, as shown by a point 110. Similarly, for compressed hydrogen at 300 degrees Kelvin (shown by a line 108), a storage density of around 40 Kg/M³ occurs at about 10,000 PSI.

A pressure of about 6,000 PSI at about liquid nitrogen temperature (point 110) has been found to be a good choice for balancing temperature and pressure considerations as it provides only about 20 Kg/M³ less storage density than liquid hydrogen at 2,000 PSI (see line 104). The point 110 indicates the estimation of the energy required to get the required state of hydrogen. In other words, point 110 indicates that in order to produce compressed, cryogenic hydrogen by the present technique, about 15.4% of the total energy content of the hydrogen, as measured by the lower heating value (LHV), is required at a pressure of 6,000 PSI and volumetric storage density of 60 Kg/M³. Similarly, as indicated in line 106, 13.9% of the LHV is required to store hydrogen at 2,000 PSI and volumetric storage density of 40 Kg/M³. Even though storage of hydrogen at about liquid nitrogen temperature and a pressure of about 6,000 PSI is desirable, pressures in the range of about 2,000 PSI to 10,000 PSI are believed to be acceptable for the present technique.

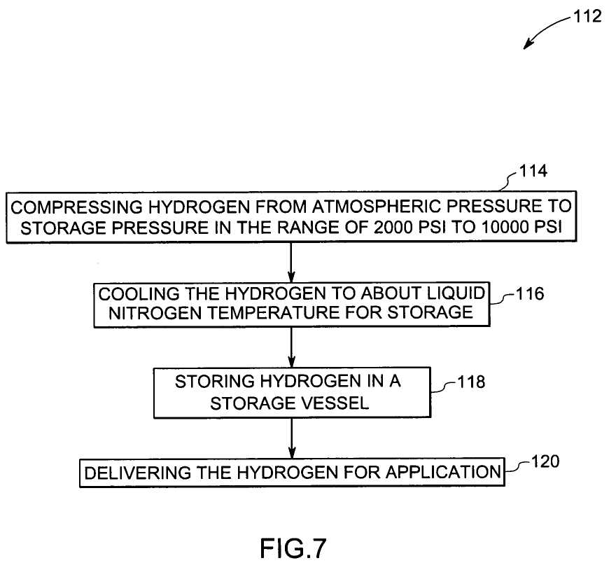

FIG. 7 is a flow diagram of an exemplary method of processing hydrogen. The diagram is generally referred to by the reference numeral 112. At step 114, hydrogen is compressed from atmospheric pressure to a storage pressure in the range of about 2,000 PSI to about 10,000 PSI. As set forth in step 116, the hydrogen is cooled to about liquid nitrogen temperature for storage. At step 118, the hydrogen is stored in a storage vessel. At step 120, the hydrogen is delivered for various applications, such as providing fuel for a vehicle.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for processing hydrogen, comprising:
at least one compressor adapted to compress hydrogen to a storage pressure in the range of 2,000 pounds per square inch (PSI) to 10,000 pounds per square inch (PSI); and
a cooling mechanism coupled to the compressor for cooling the hydrogen to a storage temperature of about liquid nitrogen temperature.

2. The system as recited in claim 1, comprising a source of hydrogen adapted to deliver hydrogen to the at least one compressor.

3. The system as recited in claim 1, wherein the storage pressure is about 6,000 pounds per square inch (PSI).

4. The system as recited in claim 1, wherein the at least one compressor comprises a first compressor to compress the hydrogen to an intermediate pressure and a second compressor to compress the hydrogen from the first intermediate pressure to the storage pressure.

5. The system as recited in claim 1, wherein the cooling mechanism comprises at least one heat exchanger.

6. The system as recited in claim 1, wherein the cooling mechanism comprises at least one heat exchanger and at least a Joule-Thomson valve.

7. The system as recited in claim 1, wherein the cooling mechanism cools the hydrogen using a nitrogen Linde cycle.

8. The system as recited in claim 1, wherein the cooling mechanism cools the hydrogen using a cascade of Linde cycles, each with a different refrigerant gas.

9. The system as recited in claim 1, wherein the cooling mechanism cools the hydrogen using a nitrogen Claude cycle.

10. The system as recited in claim 1, wherein the cooling mechanism cools the hydrogen using a mixed refrigerant cycle comprising a single compressor, at least two gaseous refrigerants mixed together, at least two Joule Thomson valves, and at least two heat exchangers.

11. The system as recited in claim 1, wherein the cooling mechanism cools the hydrogen using a magnetic refrigerator comprising a magnetocaloric regenerator and a superconducting magnet.

12. The system as recited in claim 1, wherein the cooling mechanism cools the hydrogen directly using the hydrogen in a Brayton cycle, where the hydrogen is compressed beyond the delivery pressure, cooled with air or water, and then expanded to the delivery pressure and temperature.

13. The system as recited in claim 1, wherein the cooling mechanism comprises at least one intercooler.

14. The system as recited in claim 1, further comprising a storage vessel for storing the hydrogen.

15. The system as recited in claim 14, wherein the storage vessel further comprises multilayer super insulation (MLSI).

16. The system as recited in claim 14, wherein the storage vessel is adapted to be disposed in a vehicle to provide fuel to an engine associated with the vehicle.

17. The system as recited in claim 14, wherein the storage vessel further comprises an inner vessel enclosing a storage volume and an outer vessel surrounding the inner vessel and forming an evacuated space there between.

18. A storage vessel for storing hydrogen fuel at a storage pressure in the range of 2,000 pounds per square inch (PSI) to 10,000 pounds per square inch (PSI) and a storage temperature of about liquid nitrogen temperature.

19. The system as recited in claim 18, wherein the storage pressure is about 6,000 pounds per square inch (PSI).

20. The system as recited in claim 18, wherein the storage vessel comprises an inner vessel enclosing a storage volume and an outer vessel surrounding the inner vessel and forming an evacuated space there between.

21. The system as recited in claim 18, wherein the storage vessel further comprises a thermal insulator surrounding the inner vessel in an evacuated space to inhibit heat transfer to a storage volume.

22. The system as recited in claim 18, wherein the storage vessel comprises a support positioned externally with respect to the inner vessel and the outer vessel.

23. The system as recited in claim 22, wherein the support comprises a material having a low thermal conductivity for reducing the heat transfer from the outer vessel to the inner vessel.

24. The system as recited in claim 22, wherein the outer vessel is constructed from stainless steel and the inner vessel is constructed from a material selected from the group consisting of aluminum lined composite or stainless steel.

25. The system as recited in claim 21, wherein the thermal insulator is multilayer super insulation (MLSI).

26. The system as recited in claim 25, wherein the MLSI further comprises a material having low permeability of gases and a laminate of film layers including at least one film layer, having a vacuum deposited metalized coating thereon.

27. The system as recited in claim 18, wherein the storage vessel is adapted to be disposed in a vehicle to provide fuel to an engine associated with the vehicle.

28. A method of processing hydrogen, comprising
compressing hydrogen to a storage pressure in the range of 2,000 pounds per square inch (PSI) to 10,000 pounds per square inch (PSI);
cooling the hydrogen to about liquid nitrogen temperature for storage;
storing the hydrogen in a storage vessel; and
delivering the hydrogen for application.

29. The method as recited in claim 28, wherein the storage pressure is about 6,000 pounds per square inch (PSI).

30. The method as recited in claim 28, wherein the cooling comprises of at least one heat exchanger, at least a Joule-Thomson valve and at least one intercooler, wherein the hydrogen is cooled using a Linde cycle.

31. The method as recited in claim 28, wherein the storage vessel is adapted to be disposed in a vehicle to provide fuel to an engine associated with the vehicle.

32. The method as recited in claim 28, wherein compressing hydrogen to a storage pressure is achieved by at least a compressor to compress the hydrogen to an intermediate pressure and a at least a second compressor to compress the hydrogen from the first intermediate pressure to the storage pressure.

33. A vehicle comprising:
an engine;
a power train for delivering power from the engine to one or more wheels; and
a storage vessel for storing hydrogen fuel at a storage pressure in the range of 2,000 pounds per square inch to 10,000 pounds per square inch and a storage temperature of about liquid nitrogen temperature.

34. The vehicle as recited in claim 33, wherein the storage vessel is adapted to be disposed in the vehicle to provide fuel to the engine associated with the vehicle.

35. The vehicle as recited in claim 33, wherein the storage pressure is about 6,000 pounds per square inch (PSI).

36. The vehicle as recited in claim 33, wherein the storage vessel comprises an inner vessel enclosing a storage volume and an outer vessel surrounding the inner vessel and forming an evacuated space there between.

37. The vehicle as recited in claim 33, wherein the storage vessel is adapted to be disposed in the vehicle to provide fuel to the engine associated with the vehicle.
